(19) United States
(12) Patent Application Publication
(10) Pub. No.: US 2002/0115764 A1
(43) Pub. Date: Aug. 22, 2002

(54) CHEMICAL RESISTANT INVERT CATIONIC EMULSIONS

(76) Inventor: SAMIR F. ELIAS, WICHITA, KS (US)

Correspondence Address: JAMES H. MARSH, JR., SHOOK, HARDY & BACON LLP, 1200 MAIN STREET, ONE KANSAS CITY PLACE, KANSAS CITY, MO, 64105-2118, US

(21) Appl. No.: 08/998,687

(22) Filed: Dec. 29, 1997

(51) Int. Cl. C08K 5/17

(52) U.S. Cl. 524/236

(57) ABSTRACT

The present invention relates to an acid, base and chemical resistant cationic elastomeric emulsion that can be applied to concrete at ambient temperatures. The aqueous emulsion comprises an elastomeric paste formed by dissolving a chemical resistant rubber in a solvent in the presence of a polymeric surfactant; and a cationic water solution containing amine surfactants, thickeners and stabilizers. The emulsion is compliant with volatile organic compound regulations, is free of highly flammable and high health risk solvents, is one component and is highly flexible with crack bridging capability.

### TECHNICAL FIELD

This invention relates to a one component flexible chemical resistant invert cationic emulsified coating useful in protecting concrete from attack by acids, bases and chemicals and to a method of producing same. The aqueous emulsion comprises a rubber paste and a cationic surfactant mixture, thickeners and stabilizing agents.

The present invention relates generally to protective coatings and more particularly to a water based coating exhibiting superior acid, base and chemical resistance as well as a one component application and crack bridging capability and absence of harmful, low flash point solvents such as benzene, toluene and methyl ethyl ketone.

Description of Related Art

Concrete is the most widely used permanent hard surface in waste water treatment plants to contain flow of waste and is the surface of choice around acid, base and chemical storage tanks in chemical and food processing plants as secondary containment to protect against any potential leaks. Concrete in waste water treatment facilities is constantly exposed to hydrogen sulfide gas generated by waste which results in constant deterioration of the concrete surface. Any chemical or acid leaks from a storage tank onto the concrete containment area around it can result in catastrophic deterioration of the concrete and subsequent ground water contamination due to chemical or acid permeation through the concrete surface and into the ground water.

It has therefore been known to apply a protective coating to the concrete for the purpose of protecting it from attack by chemicals, acids, bases and corrosive gases such as hydrogen sulfide. The most widely used coatings at the present time are two component epoxies or two component urethanes.

Although two component epoxies offer the desired chemical resistance, they are hard to use due to the requirement to mix two components, a resin and a curing agent just before application. This difficulty is further compounded by the short pot life of the mixture, usually less than 24 hours which can result in wasted material if rain or other unforeseen circumstances prevent application after the resin and curing agent are mixed.

Another disadvantage of two component epoxies is the lack of flexibility of the cured coating making it subject to cracking due to freeze thaw cycles thus allowing chemicals, acids, and other harmful agents to permeate through the cracks.

Two component urethanes offer slightly better flexibility after curing but lack the required chemical resistance to protect concrete from harsh chemicals such as concentrated acids and bases and does not offer protection at elevated temperatures above 100 F. In addition, urethanes lack crack bridging capability and cannot be used as crack fillers to repair existing cracks in the concrete or bridge wide cracks that may form with time as a result of freeze thaw cycles. To combine crack bridging capability and good chemical resistance, recently multilayered systems were introduced. These require the application of a non chemical resistant flexible coating directly over the concrete to offer crack bridging capability followed by an epoxy coating to protect against chemical attack. Although these coatings address the flexibility issue, they are only effective as long as the epoxy topcoat is intact. When freeze thaw cycles result in cracking of the epoxy chemical resistant layer, the lower flexible layer is exposed to direct chemical attack and fast deterioration. In addition application of such systems is labor intensive and requires extensive concrete surface preparation including priming and sandblasting.

Previous attempts have been made to address this problem by using chemical resistant rubbers such as chlorosulfonated polyethylene in solvent solutions. These type of products involved dissolving the rubber in a solvent, mainly benzene, toluene or xylene adding pigments and using the material as a coating. These products were unsuccessful in offering chemical resistance due to the large amount of solvents used, usually as much as 70 percent of the total composition. Such large solvent amounts resulted in difficulty achieving complete solvent evaporation and solvent residue remaining in the film. In addition these systems have significant health risks, are highly flammable, and do not meet Volatile Organic Compound (VOC) regulations.

To improve chemical resistance of these products a two component system was used whereby an amine curing agent was added to the rubber solution before application. Although this improved chemical resistance, it eliminated the single component advantage of the product and created application problems similar to the ones encountered in two component epoxies.

To reduce the amount of solvent used attempts have been made to replace part of the solvent used in the coatings by a water surfactant mixture. These attempts are manifested in Chinese patents # 1030436, 1036027 and 1034214. The approach used involves the emulsification of a 20% solution of chlorosulfonated polyethylene in benzene using a water system containing anionic emulsifiers such as ethoxylated castor oil, fillers and other additives.

Although these approaches resulted in some improvements in chemical resistance, as indicated in Chinese patent # 1036027 by offering good resistance to 20% sulfuric acid for 24 hours at room temperature; the performance still falls short of offering resistance to concentrated acids up to 97% concentrations and over 100 degrees F. temperatures.

Further disadvantages of these systems are the use of large amounts of benzene which is a high health risk solvent and highly flammable, as well as the low amount of water used (3-5%) which limit the amount of solvent reduction in the overall composition. Further problems with these systems is manifested by the necessity to sandblast or prime concrete before application and slow drying in high humidity areas such as waste water treatment facilities.

It is therefore an object of the present invention to provide an emulsified protective coating offering one component application wherein the emulsion residue exhibits high degree of flexibility.

It is another object of the invention to provide an emulsified protective coating offering one component application free of highly flammable and unhealthy solvents such as benzene, toluene, xylene and methyl ethyl ketone.

Still another object of the invention is to provide an emulsified protective coating offering one component application wherein the residue offers excellent resistance to concentrated acids, bases and numerous chemicals to 250 degrees F.

A further object of the invention is to provide an emulsified protective coating offering one component application that is compliant with VOC regulations and nonflammable in liquid form.

Another object of this invention is to provide an emulsified protective coating offering one component application that can be applied to concrete without priming or sandblasting so as to save application times and surface preparation costs.

Still another object of this invention is to provide an emulsified protective coating offering one component application that can offer excellent adhesion to concrete and fast drying in high humidity areas.

A further object of this invention is to provide an emulsified protective coating offering one component application wherein the emulsifier system is cationic in nature.

Another object of the invention is to provide an emulsified protective coating offering one component application which can be used to repair existing cracks in concrete before application as protective coating.

### BRIEF SUMMARY OF THE INVENTION

These and other objects of the present invention are achieved by a stable aqueous emulsion comprising polymeric surfactants and a rubber paste formed by dissolving a chemical resistant rubber in an appropriate high boiling solvent. The emulsion is formed by combining the said rubber paste with a cationic water solution comprising amine surfactants, thickeners and stabilizers. The resulting emulsion is stable for more than one year, is one component and can be applied to concrete without sandblasting or priming using conventional spray or roller equipment and dries fast even in high humidity areas. The residue is highly flexible, can be used as crack filler, can bridge cracks in concrete as they occur and can resist concentrated acids, bases and chemicals up to 250 degrees F.

### DETAILED DESCRIPTION OF THE PRESENT INVENTION

The emulsified rubber composition of the present invention is prepared in a three step process. The first step is accomplished by dissolving a chemical resistant elastomer in a high boiling solvent at a temperature ranging from 75 degrees to 300 degrees F. and preferably at 225 degrees F. The dissolution process can take from anywhere between 1 hour to 30 hours dependent on the composition of the mixture and the temperature used. One or more polymeric surfactants usually of the modified polyester type can be added to the solution to speed up the dissolving process and facilitate further emulsification.

The second step of the emulsification involves the preparation of a cationic water solution containing cationic surfactants preferably a combination of polyamine and diamine surfactants. In addition to the surfactants, the solution contains a thickener preferably an acrylamide and a stabilizer, preferably vinyl alcohol. A defoamer can also be added to reduce foaming during the mixing process. Hydrochloric acid is then added to adjust the PH of the solution between 0 to 5 with 0 to 3 being most preferred.

In the final step the water surfactant solution is heated to between 100 degrees F. to 220 degrees F. with preferred temperature being around 200 F. and is added to the rubber paste which is maintained at about 75 to 300 degrees F. with 225 degrees F. being preferred. The mixing is accomplished using a two blade mixer containing a slow rotating sweeping blade with ranges between 100 to 500 rpm and a high shear cowles blade rotating between 1000 to 7000 rpm. The sweeping blade is initially started and the water solution is added until the mix viscosity is reduced enough to allow free rotation of the high speed mixing blade at which point the high speed blade is started. During the mixing process a colorant can be added, preferably white such as titanium dioxide and black such as carbon black to form the desired light gray concrete type color.

The elastomer ingredient of the present composition can comprise any rubbery or elastomeric material including natural and synthetic rubbers either alone or in an elastomeric blend. However, to achieve desired chemical, acid and base resistant properties, it is preferred that the elastomers chosen have inherent chemical resistance. Particularly suitable elastomers include chlorosulfonated polyethylene and Fluoroelastomers. The percentage of elastomer can range from 10 percent to 70 percent of the total composition with the preferred range being 35 to 60 percent of the total composition.

The solvent used to is chosen based on several factors including health data, VOC content, boiling point, evaporation rate and its ability to dissolve the desired elastomer. The solvent can be aromatic, aliphatic, ketone, ether, and can be chlorinated or fluorinated. The following should be used as a guideline for selecting the solvent: the boiling point should be 50 degrees F. above the dissolution temperature of the elastomer. As an example for the preferred dissolution temperature of 225 degrees F. solvents with boiling points above 275 degrees F. should be selected. The solvent should have a fast enough evaporation rate to insure adequate solvent evaporation upon application of the emulsion. Evaporation rates of 0.5 or less should be chosen and health ratings of no more than 1 should be selected. The solvent should be selected so that the final emulsion is VOC compliant and more specifically contains less than 2 lbs/gal of VOC. Preferred solvents include high boiling, aromatic blends such as Aromatic 100 Aromatic 150 and Aromatic 200 produced by Exxon Chemical chosen for their high boiling point, and high solvency at elevated temperature. Other preferred solvents of the chlorofluorinated type include parachlorobenzotrifluoride available from Oxychem under the trade name Oxsol. This solvent is chosen because it is exempt from VOC regulations and has high solvency at elevated temperatures. Still another preferred solvent is a combination of alkoxypropanols and terpene hydrocarbons supplied by Dow chemical under the trade name Invert 2000 structured solvent. This solvent is chosen due to its high solvency, low VOC and high boiling point.

An additional preferred solvent is Acetone chosen due to being exempt from VOC regulations, its capability to dissolve fluoroelastomers at room temperature and its relative low health risk. The solvent content can range from 10% to 70% of the total composition with the preferred amount being between 20 to 30%. The polymeric surfactant used to enhance the emulsification of the rubber paste and speed up the solubility of the rubber is preferably of the polyester type and is added in an amount of 0.1 to 3% by weight of the total composition; preferably between 0.2 to 2% by weight of the total emulsion. A particularly suitable polymeric surfactant is a modified polyester surfactant having a high molecular weight such as commercially available under the trade designation Hypermer B 246 from IGI Americas. This surfactant is particularly useful in emulsification so that the solvent elastomer paste viscosity does not have to be low to permit emulsification.

In a preferred embodiment of the invention a Chlorosulfonated polyethylene elastomer in an amount ranging from 30 to 60% of the total composition is combined with a high boiling aromatic solvent in an amount of 10 to 30% of the total composition. Chlorosulfonated polyethylene can be commercially obtained from E.I Dupont under the trade name Hypalon. Preferably the solvent is a high boiling aromatic solvent mixture free of toluene, xylene and such high health risk solvents, such as that available from Exxon Chemical under the trade name Aromatic 100 or the one available from Oxycheml Chemical under the name Oxsol 100.

A polymeric surfactant is then added to the mixture in an amount of 0.1 to 1 percent of the total composition. The polymeric surfactant is of the polyester type such as that available from ICI Americas under the trade name Hypermer B246. The mixture is then heated to a temperature between 200 to 250 degrees F. for 1 to 30 hours and preferably 5 to 24 hours until a homogeneous rubber paste is formed.

In another preferred embodiment of the invention, a fluoroelastomer is used instead of chlorinated polyethylene, while Acetone is used instead of an aromatic solvent. A suitable fluoroelastomer is available from E.I Dupont under the trade name Viton. The percentages of elastomers and solvent used are similar to the description in the previous preferred embodiment. A polymeric surfactant is then added as described above and the solution is allowed to stand at room temperature until a homogenous rubber paste is formed.

The emulsification medium may comprise any of the widely known and well used emulsifiers and can be cationic, anionic or nonionic with cationic preferred. It should be noted that although anionic emulsifiers can be used the dry time of the emulsion prepared as such will be unsuitably long and adhesion to concrete will not be good and may require that the concrete be primed or sandblasted before application of the coating. Hence cationic emulsifiers are preferred and the fatty amines, most desirably a polyamine are particularly useful in combination with diamines. The emulsifying agents should be present in amounts from 0.1 to 5% of the total emulsion. Optionally A viscosity modifier of the polyacrylamide type is added in amounts ranging from 0.01 to 0.2 percent of the total composition and a stabilizer preferably vinyl alcohol is also optionally added in amounts ranging from 0.1 to 3% of the total composition.

In accordance with the best mode of preparation of the cationic emulsifier solution, a mixture of the polyamine emulsifier in the amounts ranging from 0.2 to 3% by weight, preferably 0.3 to 1.5% by weight of the emulsion and a diamine in amounts ranging from 0.05 to 1% by weight and preferably 0.06 to 0.5% by weight of the emulsion is used. A suitable polyamine emulsifier is a tallow amine available from Akzo Nobel under the trade designation Redicote E-7A. A suitable diamine is available from Akzo Nobel under the trade name Redicote E-22. A minor amount of mineral acid preferably Hydrochloric acid can be added to the emulsification medium to maintain a solution PH between 0 and 3. A suitable amount of acid for this purpose is 0.05 to 1% by weight of the total emulsion, with a preferred range of 0.1 to 0.5%. Optionally, a viscosity modifier is added to the emulsification medium to thicken the water solution. Suitable amounts range from 0.02 to 0.15% of the weight of the emulsion with a preferred range of 0.05 to 0.1%. A useful viscosity modifier is a polyacrylamide such as commercially available from Cytec industries under the trade name Cyanamer N-300. A viscosity stabilizer can optionally be added in amounts between 0.2 to 2% of the total emulsion with a preferred range of 0.5 to 1.5%. A useful viscosity stabilizer is a polyvinyl alcohol available from Air Products & Chemicals under the trade name Vinol 325. A defoamer can also be optionally added in amounts ranging between 0.1 and 2% of the total emulsion with 0.2 to 1% being preferred. A useful defoamer is a nonsilicone oil type such as that commercially available from Ultra Additives under the trade name Deefo 97-3.

The emulsification process is accomplished by combining the rubber paste with the cationic emulsification medium in a two shaft mixer containing a low speed sweeping blade and a high shear blade. Such equipment is standard in the industry and is commercially available from several suppliers including Myers Engineering, Ross Mixers & Hockmeyer. The solids content of the emulsion should range from 30 to 75%, preferably 40 to 60%; and most preferably 45 to 55%.

Following emulsification, a pigment is added to the emulsion in the range from about 0.5 to 6% and preferably from 0.75 % to 4% by weight of the total emulsion to give a white color. A suitable pigment includes titanium dioxide such as that commercially available under trade designation Kemira OR 620 from Kemira Pigments. Carbon black is also added to the emulsion in amounts ranging from 0.01% to 0.5% of the total emulsion composition, preferably between 0.02to 0.2% of the total emulsion to obtain concrete like gray color. Suitable carbon blacks include both powder and liquid blacks with liquid preferred. A suitable liquid Carbon black is available under the trade name Permablack 2847A while a suitable powdered carbon black is available under the trade name Permablack 900 both from Monochem Chemical.

While the above describes the invention with sufficient particularity to enable those skilled in the art to make or use same, nonetheless further examples follow.

Table I sets forth preferred ranges and a suitable composition made in accordance with the best mode of this invention.

TABLE I
(All compositions are weight % of total)

| INGREDIENT | RANGE | PREFERRED | COMPOSITION I |
|---|---|---|---|
| Elastomer | 10-70 | 35-60 | 41.1 |
| Solvent | 10-70 | 20-30 | 22.1 |
| Polymeric Surfactant | 0.1-3 | 0.2-2 | 0.31 |
| Water | 15-45 | 20-40 | 28.9 |
| Polyamine emulsifier | 0.2-3 | 0.3-1.5 | 1.08 |
| Diamine Emulsifier | 0.05-1 | 0.06-0.5 | 0.36 |
| Acid | 0.05-1 | 0.1-0.5 | 0.23 |
| Viscosity Modifier | 0.02-0.15 | 0.05-0.1 | 0.09 |
| Viscosity Stablizer | 0.2-0.2 | 0.5-0.15 | 0.90 |
| Defoamer | 0.1-2 | 0.2-0.1 | 0.54 |
| Pigment | 0.5-6 | 0.75-4 | 3.6 |
| Carbon Black | 0.01-0.05 | 0.02-0.2 | 0.025 |

Table II lists several compositions made in accordance with the present invention. These compositions demonstrate the flexibility of the present invention by using different elastomers as well as different types of solvents. Composition II and V demonstrate the use of both preferred elastomers, Chlorosulfonated polyethylene; specifically Hypalon and Fluoroelastomers; specifically Viton. The solvents chosen are also different, to reflect the different solubilities of these elastomers.

Compositions II, IlI and IV demonstrate the use of different solvents while keeping the same elastomer. Composition II demonstrate the use of an Aromatic solvent specifically Aromatic 100, while composition III demonstrates the use of a combination system including Aromatic 100 and a terpene hydrocarbon/Alkoxypropanol mixture, namely Invert 2000. On the other hand composition IV demonstrates the use of a fluorinated solvent namely, Oxsol 100. In compositions I, II, III and IV; the elastomer was dissolved in the solvent at an elevated temperature of 225 F. This was preferable since the solvents used had a high boiling point and low volatility. In composition V room temperature was used to dissolve the rubber. This was the preferred choice due to the low boiling point and high volatility of acetone.

TABLE II
(All compositions are weight % of total)

| INGREDIENT | COMPOSITION II | COMPOSITION III | COMPOSITION IV | COMPOSITION V |
|---|---|---|---|---|
| HYPALON | 38.5 | 37.8 | 42.1 | x |
| VITON | x | x | x | 44.5 |
| AROMATIC 100 | 24.5 | 20.4 | x | x |
| INVERT 2000 | x | 8.3 | x | x |
| OXSOL 100 | x | x | 20.5 | x |
| ACETONE | x | x | x | 18.7 |
| HYPERMER B246 | 0.32 | 0.29 | 0.31 | 0.32 |
| WATER | 29.63 | 26.5 | 29.96 | 29.73 |
| REDICOTE E-7A | 1.1 | 1.0 | 1.15 | 1.2 |
| REDICOTE E22 | 0.34 | 0.33 | 0.35 | 0.34 |
| HCL | 0.23 | 0.25 | 0.25 | 0.25 |
| CYANAMER N-300 | 0.09 | 0.09 | 0.09 | 0.06 |
| VINOL 325 | 0.90 | 0.90 | 0.90 | 0.60 |
| DEEFO 97-3 | 0.57 | 0.61 | 0.57 | 0.58 |
| UNITANE OR-620 | 3.8 | 3.5 | 3.8 | 3.7 |
| PERMABLACK 900 | 0.02 | x | x | 0.02 |
| PERMABLACK 2847A | x | 0.03 | 0.025 | x |

x indicates that ingredientis not present

The following table lists selected physical properties of the prepared compositions. It is worthwhile noting that the dried film physical properties of samples I to IV are very similar. This is a reflection of the fact that the same elastomer has been used, namely Hypalon. This confirms the almost complete solvent evaporation from the system so as the film left is almost exclusively the elastomer used in addition to the pigments and additives included.

The differences in physical properties seen in sample V is a reflection of the different base rubber used namely Viton. The zero VOC content in samples IV and V is a result of using Acetone and Oxsol 100 which are exempt from VOC regulations. The higher VOC amount in sample II is reflective of the higher percentage of Aromatic 100 used in that sample. It is important to note that although sample III has a higher total solvent percent, it has lower VOC content than samples I and II. This is due to the fact that the Invert 2000 solvent used already contains 50% water as supplied by the manufacturer.

TABLE III
Selected Physical Properties of Prepared Compositions

| | I | II | III | IV | V |
|---|---|---|---|---|---|
| Liquid Properties | | | | | |
| VOC Content (lbs/gal) | 1.5 | 1.7 | 1.4 | ZERO | ZERO |
| Flammability | NONE | NONE | NONE | NONE | NONE |
| Dried Film Properties | | | | | |
| Tensile (at 75 F.) | 1200 psi | 1195 psi | 1205 psi | 1200 psi | 1800 psi |
| Elongation (at 75 F.) | 300% | 305% | 295% | 300% | 250% |
| Water Absorption (ASTM D 471) | 0.051% | 0.048% | 0.053% | 0.05% | 0.035% |

Table IV shows the performance of the dried films from different compositions when subjected to selected acids, bases and solvents. It is important to note that compositions I through IV have similar performance when subjected to the same medium since the base elastomer used is the same. Composition V offers better resistance to some mediums where the other compositions fail to perform which is due to the highly chemical resistant fluoroelastomer used, namely Viton. This fact shows the high degree of flexibility of this invention, since resistance to a wide variety of Chemicals, Acids and Bases can be obtained by appropriate selection of the elastomer in the composition.

TABLE IV
Chemical Resistance of Dried Films
Drying Conditions: 24 hours at 77 degrees F.
Dried Film thickness: 20 mils

| | | COMPOSITIONS | | | | |
|---|---|---|---|---|---|---|
| Medium | Temperature F. | I | II | III | IV | V |
| Sulfuric Acid (97%) | 77 | G | G | G | G | G |
| Sulfuric Acid (50%) | 250 | G | G | G | G | G |
| Hydrochloric Acid (37%) | 250 | G | G | G | G | G |
| Hydrofluoric Acid (97%) | 77 | G | G | G | G | G |
| Naphtenic Acid (50%) | 77 | P | P | P | P | G |
| Calciun Hydroxide (50%) | 250 | G | G | G | G | G |
| Sodium Hydroxide (50%) | 250 | G | G | G | G | G |
| Potassiun Hydroxide (50%) | 250 | G | G | G | G | G |
| Benzene | 77 | P | P | P | P | G |
| Ethanol | 77 | G | G | G | G | G |
| Gasoline | 77 | p | P | P | P | G |
| Glycol | 77 | G | G | G | G | G |
| Mineral Oils | 77 | G | G | G | G | G |
| Naphta | 77 | P | P | P | P | G |
| Acetone | 77 | G | G | G | G | P |
| Water | 77 | G | G | G | G | G |

All tests are performed at prescribed conditions for 72 hours
G = Good. No visible effects on film, less than 0.1% weight gain
P = Poor. Significant film softening, more than 1% weight gain

1. We claim An aqueous elastomeric emulsion that is pourable at room temperature comprising:
35-60 percent by weight elastomer
20-30 percent by weight solvent
Said elastomer and solvent being combined to form a paste at 75-300 degrees F. with a polymeric surfactant present in a quantity of 0.2 to 2 percent by weight of the total emulsion; 0.3 to 2 percent emulsifier and water.

2. We claim An emulsion according to claim 1 wherein the elastomer is chemical resistant.

3. We claim An emulsion according to claim 1 wherein the elastomer is acid and base resistant

4. We claim An emulsion according to claim 1 where the elastomer is Chlorosulfonated Polyethylene.

5. We claim An emulsion according to claim 1 wherein the elastomer is a fluoroelastomer.

6. We claim An emulsion according to claim 1 wherein the solvent has a boiling point above 275 degrees F.

7. We claim An emulsion according to claim 1 wherein the solvent has a health rating of 1 or less.

8. We claim An emulsion according to claim 1 wherein the solvent is an aromatic blend

9. We claim An emulsion according to claim 1 wherein the solvent is a fluorinated solvent.

10. We claim An emulsion according to claim 1 wherein the solvent is a mixture of alkoxypropanols and terpene hydrocarbons.

11. We claim An emulsion according to claim 1 wherein the solvent is Acetone

12. We claim An emulsion according to claim 1 wherein said polymeric surfactant is a high molecular weight polyester.

13. We claim An emulsion according to claim 1 wherein said emulsion additionally comprises a polyacrylamide viscosity modifier.

14. We claim An emulsion according to claim 1 wherein said emulsion additionally comprises a vinyl alcohol viscosity stabilizer.

15. We claim An emulsion according to claim 1 wherein said emulsifier is cationic in nature

16. We claim An emulsion according to claim 1 wherein said emulsifier is a combination of polyamine and diamine.

17. We claim An emulsion according to claim 1 wherein said emulsion additionally comprises a titanium dioxide pigment.

18. We claim An emulsion according to claim 1 wherein said emulsion additionally comprises a carbon black colorant.

19. We claim An emulsion according to claim 1 where in said emulsion is compliant with volatile organic compound regulations (VOC) when applied.

20. We claim An emulsion according to claim 1 wherein said emulsion contains no more than 2 lbs/gallon of volatile organic compounds (VOC).
